(19) United States
(12) Patent Application Publication
(10) Pub. No.: US 2024/0290332 A1
(43) Pub. Date: Aug. 29, 2024

(54) KNOWLEDGE DISTILLATION FROM NON-STREAMING TO STREAMING ENCODER

(71) Applicant: QUALCOMM Incorporated, San Diego, CA (US)

(72) Inventors: Kyuhong Shim, Seoul (KR); Jinkyu Lee, Seoul (KR); Simyung Chang, Suwon (KR); Kyu Woong Hwang, Daejeon (KR)

(21) Appl. No.: 18/355,055

(22) Filed: Jul. 19, 2023

Related U.S. Application Data
(60) Provisional application No. 63/487,449, filed on Feb. 28, 2023.

(51) Int. Cl. G10L 15/22; G10L 15/18; G10L 15/26

(52) U.S. Cl. CPC G10L 15/22; G10L 15/18; G10L 15/26; G10L 2015/223

(57) ABSTRACT

An example device includes memory configured to store a speech signal representative of speech and a streaming model. The streaming model includes an on-device, real-time streaming model. The device includes one or more processors implemented in circuitry coupled to the memory. The one or more processors are configured to determine one or more words in the speech signal based on one or more transfers of learned knowledge from a non-streaming model to the streaming model. The one or more processors are also configured to take an action based on the determined one or more words.

This application claims the benefit of U.S. Provisional Application No. 63/487,449, filed Feb. 28, 2023, the entire contents of which is incorporated herein by reference.

### TECHNICAL FIELD

This disclosure relates to non-streaming and streaming model encoders.

### BACKGROUND

Automatic speech recognition (ASR) models may be used to automatically recognize speech, such as words, facilitating the processing of such speech into text, commands, queries, or the like. ASR models may be part of popular digital assistants which may include stand-alone virtual assistant devices, smartphone applications, or the like.

### SUMMARY

This disclosure relates generally to techniques and devices for speech related streaming models, such as ASR models, and to training techniques for such models. Various aspects of the techniques of this disclosure may provide for improved streaming model performance. While the techniques of this disclosure are generally discussed in terms of ASR models, these techniques may be applicable to any speech related models that may be categorized as either non-streaming or streaming.

There may be an information gap between non-streaming ASR models and streaming ASR models, with non-streaming ASR models normally performing better than streaming ASR models. However, non-streaming ASR models may have issues as well. Processing associated with streaming ASR models typically has a much lower latency because there is no need to wait for the speech (e.g., utterance) to end prior to starting the processing of the captured utterance. Therefore, non-streaming ASR models may not be desirable for on-device (e.g., not in a cloud computing environment), real-time ASR as the latency attributes of streaming ASR models may be more suited for on-device, real-time ASR.

Knowledge distillation (KD) is a technique that may be used to transfer learned knowledge from one model (sometimes referred to as a teacher) to another model (sometimes referred to as a student). For example, KD may be used to distill or compress one or more large models to train a smaller model. KD techniques may be used to improve the performance of streaming ASR models, while maintaining the latency benefits of streaming ASR models. For example, a streaming ASR model student may be trained by applying KD techniques from a non-streaming ASR model teacher. In such a case, a streaming ASR model (the streaming ASR model student) may mimic behavior of a non-streaming ASR model teacher.

However, there may be difficulties in applying KD from non-streaming ASR model teacher to a streaming ASR model student. Because non-streaming ASR models and streaming ASR models may use very different contexts, streaming ASR model students may often fail to follow the non-streaming ASR model teacher. Previous KD studies have applied distillation for final output probabilities, but such an approach may have problems: (1) all data may require labeling (e.g., a text transcription of captured audio data); and (2) the alignment of output data is usually not matched (e.g., the output data is misaligned) between the non-streaming ASR model teacher and the streaming ASR model student.

As such, it may be desirable to overcome these difficulties in applying KD from a non-streaming model teacher to a streaming model student. According to the techniques of this disclosure, a system may apply KD only to an encoder of the system, which may be a part (e.g., not all) of the entire model. The techniques of this disclosure may result in faster training and/or processing, may not require labeling of all data, and may not result in output misalignment between the non-streaming model teacher to streaming model student.

In one example, various aspects of the techniques are directed to a device including memory configured to store a speech signal representative of speech and streaming model, the streaming model including an on-device, real-time streaming model; one or more processors implemented in circuitry coupled to the memory, the one or more processors being configured to: determine one or more words in the speech signal based on one or more transfers of learned knowledge from a non-streaming model to the streaming model; and take an action based on the determined one or more words. . . .

In another example, various aspects of the techniques are directed to a method including determining one or more words in a speech signal based on one or more transfers of learned knowledge from a non-streaming model to a streaming model, the streaming model including an on-device, real-time streaming model; and take an action based on the determined one or more words.

In another example. various aspects of the techniques are directed to a method including transferring learned knowledge from a non-streaming model to an on-device, real-time streaming model.

In another example, various aspects of the techniques are directed to a non-transitory computer-readable storage medium having stored thereon instructions that, when executed, cause one or more processors to determine one or more words in a speech signal based on one or more transfers of learned knowledge from a non-streaming model to a streaming model, the streaming model including an on-device, real-time streaming model; and take an action based on the determined one or more words.

In another example, various aspects of the techniques are directed to a device including means for determining one or more words in a speech signal based on one or more transfers of learned knowledge from a non-streaming model to a streaming model. the streaming model including an on-device, real-time streaming model; and means for take an action based on the determined one or more words.

The details of one or more examples of this disclosure are set forth in the accompanying drawings and the description below. Other features, objects, and advantages of various aspects of the techniques will be apparent from the description and drawings, and from the claims.

### BRIEF DESCRIPTION OF DRAWINGS

FIG. 1 is a block diagram of an example system for automatic speech recognition according to the techniques of this disclosure.

FIG. 2 is a block diagram illustrating an implementation of a system for training a streaming model according to the techniques of this disclosure.

FIG. 3 is a block diagram illustrating example application of KD from a non-streaming ASR model encoder teacher to a streaming ASR model encoder student according to the techniques of this disclosure.

FIG. 4 is a conceptual diagram illustrating an example use of a KD loss function according to the techniques of this disclosure.

FIG. 5 is a conceptual diagram illustrating example transformer attention masks according to the techniques of this disclosure.

FIG. 6 is a chart illustrating test results of streaming ASR model encoders.

FIG. 7 is a block diagram illustrating an example of a device according to the techniques of this disclosure.

FIG. 8 is a flow diagram illustrating example techniques for KD from a non-streaming to a streaming encoder according to one or more aspects of this disclosure.

### DETAILED DESCRIPTION

ASR models may be categorized into two groups: non-streaming ASR models or streaming ASR models. Non-streaming ASR models may use an entire captured audio signal to transcribe a captured utterance (e.g., phrase, sentence, command, query, etc.). An utterance may be a continuous piece of speech or an uninterrupted chain of spoken language which may begin and/or end with a pause. For example, an utterance may be a word, a sentence, or a sentence fragment (e.g., one or more words). The entire captured audio signal may include the captured utterance. As such, a non-streaming ASR model may not make an inference about the captured audio signal (e.g., what word(s) were in the spoken utterance) until the entire utterance is captured. A non-streaming ASR model may be implemented as a neural network having a plurality of non-streaming layers. Each layer of the non-streaming ASR model may perform a specific task. Such layers may include an input layer, an output layer, and one or more hidden layers.

Steaming ASR models may only use the past context and thus, may not need to use the entire captured utterance. For example, streaming ASR models may make an inference in real-time based on a portion of an utterance captured up to that point in time. In some examples, steaming ASR models may update the inference as more of the utterance is captured. A streaming ASR model may be implemented as a neural network having a plurality of streaming layers. Speech related models other than ASR models may also be categorized as non-streaming or streaming. Each layer of the streaming ASR model may perform a specific task. Such layers may include an input layer, an output layer, and one or more hidden layers.

Because there is an information gap between non-streaming ASR models and streaming ASR models, non-streaming ASR models normally perform better than streaming ASR models (which usually perform worse). However, processing associated with streaming ASR models typically has a much lower latency because there is no need to wait for the speech (e.g., utterance) to end prior to starting the processing of the captured utterance. Therefore, the latency attributes of streaming ASR models are desirable for on-device real-time ASR.

KD techniques may be used to transfer learned knowledge from a non-streaming ASR model to a streaming ASR model in an attempt to improve the performance of a streaming ASR model while maintaining the latency benefits of the streaming ASR model. However, there may be difficulties in applying KD from non-streaming ASR model teacher to a streaming ASR model student. Because non-streaming ASR models and streaming ASR models may use very different contexts, a streaming ASR model student may often fail to follow the non-streaming ASR model teacher. Additionally, if KD is applied for final output probabilities, all data may require labeling (e.g., a text transcription of captured audio data); and (2) the output data will likely be misaligned between the non-streaming ASR model teacher and the streaming ASR model student which may negatively affect further training. As such, it may be desirable to overcome these difficulties in applying KD from a non-streaming ASR model teacher to a streaming ASR model student.

This disclosure relates to systems, devices, and techniques for applying, and that may result from applying, KD only to encoders of ASR models. Such an encoder may be a part (e.g., not all) of an entire ASR model. The techniques of this disclosure may result in faster training and/or processing, may not require labeling of all data, and may not result in output misalignment between the non-streaming ASR model teacher to streaming ASR model student.

Such techniques may include using auxiliary non-streaming layers during training. Additionally, or alternatively, the system may include a specialized loss function for KD from the non-streaming ASR model teacher to streaming ASR model student. The techniques of this disclosure may achieve a clear margin of improvement compared to other techniques and may not require labeled data, thereby fundamentally removing the heavy data labeling cost. The techniques of this disclosure may provide no additional overhead for the inference stage (e.g., the streaming ASR model making inferences after training).

The techniques of this disclosure may improve on-device, real-time streaming ASR models, for example, running on smartphones or other devices. The techniques of this disclosure may improve streaming ASR model performance for various speech-related tasks, such as keyword detection, voice assistance, speaker verification, or the like.

Systems, devices, and methods for performing automatic speech recognition are disclosed. A system of the present disclosure is configured to automatically recognize speech and take an action based on the recognized speech (e.g., elements of the recognized speech, such as words of an utterance). The system may be integrated into a device, such as a mobile device, a smart speaker system (e.g., a speaker within a user's home that is capable of playing audio, receiving spoken user commands, and performing actions based on the user commands), a vehicle, a robot, or the like.

To illustrate, a user may be in the kitchen using cutlery and speak the command “turn on the kitchen light.” The system may receive audio data that corresponds to the user's speech (e.g., “turn on the kitchen light”). The system may identify the words within the utterance “turn on the kitchen light” and respond by taking the action of turning on the kitchen light.

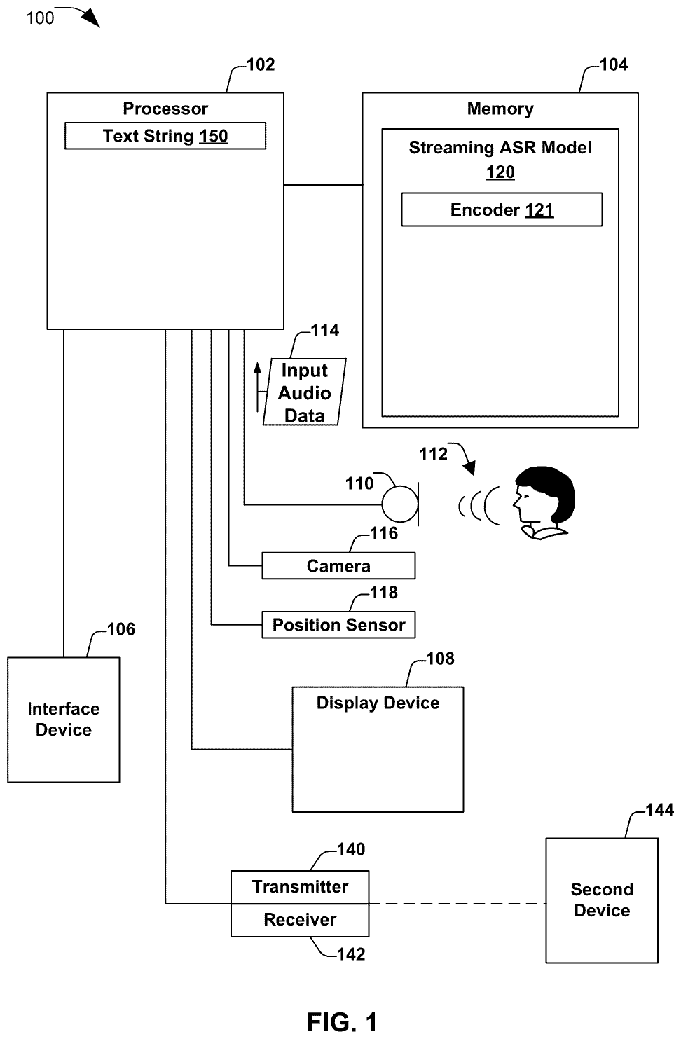

FIG. 1 is a block diagram of an example system for automatic speech recognition according to the techniques of this disclosure. A system 100 includes a processor 102, memory 104 coupled to the processor 102, a microphone 110, a transmitter 140, and a receiver 142. The transmitter 140 and the receiver 142 may be configured to facilitate the interaction of system 100 with a second device 144 (e.g., the kitchen light switch or another device). The system 100 may optionally include an interface device 106, a display device 108, a camera 116, and a position sensor 118. In some examples, the system 100 is implemented in a smart speaker system (e.g., a wireless speaker and voice command device that is integrated with a virtual assistant). In other examples, the system 100 is implemented in a mobile device, such as a mobile phone (e.g., a smartphone), a laptop computer, a tablet computer, a computerized watch, etc. In other examples, the system 100 is implemented in one or more Internet of Things (IoT) devices, such as smart appliances or the like. In other examples, the system 100 is implemented in a vehicle, such as an automobile or a self-driving vehicle or the like. In other examples, the system 100 is implemented in a robot. The system 100 is configured to perform automatic speech recognition and take an action based on the recognized speech.

The processor 102 is configured to automatically recognize speech, such as a spoken utterance, and to perform one or more tasks based on the recognized speech. Such tasks may include processing of recognized speech into text, responding to commands, responding to queries (such as a request for information from the Internet by retrieving information therefrom), or the like. For example, processor 102 may be configured to identify a particular spoken word or words of an utterance and take an action based on the identity of the word(s). The memory 104 is configured to store a streaming ASR model 120 including an encoder 121. Although the streaming ASR model 120 is illustrated as being stored at the memory 104 of the system 100 (e.g., an on-device model), in other implementations, the streaming ASR model 120 (or a portion thereof) may be stored remotely in a network-based storage (e.g., “the cloud”). The encoder 121 may include a plurality of streaming layers. In some examples, the encoder 121 does not include any non-streaming layers. For example, when the encoder 121 has already been trained, the encoder 121 may not include any non-streaming layers.

The microphone 110 (which may be one or more microphones) is configured to capture an audio input 112 (e.g., speech) and to generate input audio data 114 (e.g., a speech signal) based on the audio input 112. The audio input 112 may include an utterance (e.g., speech) from a speaker (e.g., a person).

The processor 102 is configured to automatically recognize the input audio data 114. For example, the processor 102 may execute the streaming ASR model 120 to automatically recognize the input audio data 114. For example, the processor 102 may compare the input audio data 114 (or a portion thereof) to known models for different words as part of automatically recognizing the words represented by the input audio data 114. Such models may be learned by the streaming ASR model 120 as described in this disclosure.

The processor 102 may take an action based on the recognized input audio data 114. For example, the processor 102 may process recognized speech into text, respond to commands, respond to queries, or the like. In some examples, the action may include converting the recognized input audio data 114 into a text string 150. For example, the processor 102 may be configured to perform speech to text conversion on the input audio data 114 to convert the input audio data 114, or a portion thereof that includes speech, into the text string 150. The text string 150 may include a textual representation of the speech included in the input audio data 114.

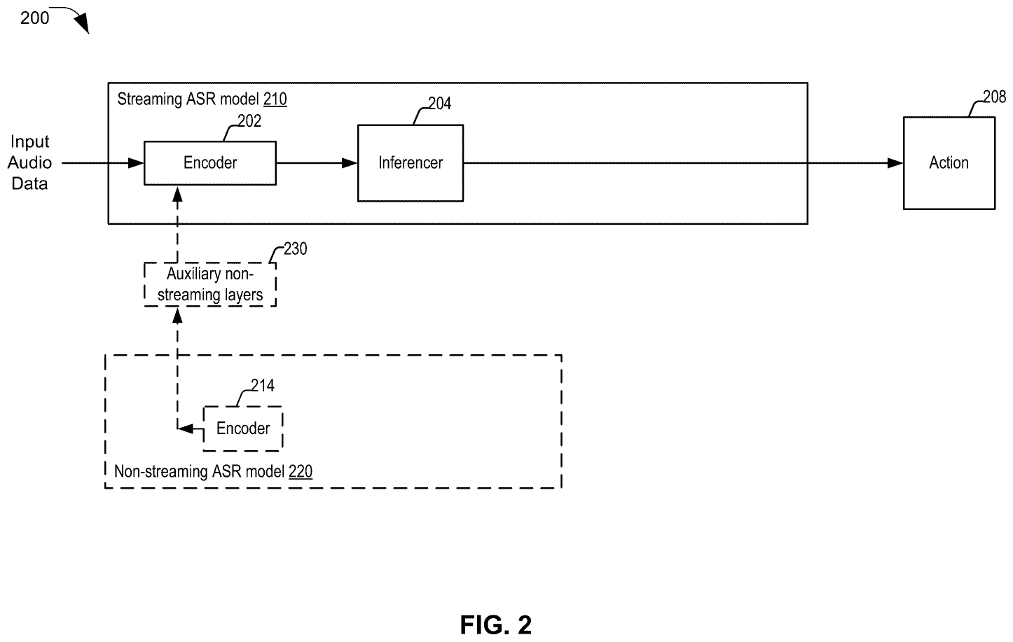

FIG. 2 is a block diagram illustrating an implementation of a system for training a streaming model according to the techniques of this disclosure. In some examples, the system 200 may include or correspond to the system 100 or portions thereof. For example, the elements of the system 200 may include or correspond to hardware within the processor 102. Streaming ASR model 210 may be an example of streaming ASR model 120. Each of the elements of the system 200 may be represented in hardware, such as via an application-specific integrated circuit (ASIC) or a field-programmable gate array (FPGA), or the operations described with reference to the elements may be performed by one or more processors executing computer-readable instructions.

The system 200 includes a streaming ASR model 210. The streaming ASR model 210 includes an encoder 202 and an inferencer 204. The encoder 202 may include a plurality of streaming layers and may be configured to receive input audio data, such as the input audio data 114 and to encode the input audio data 114 to be used by inferencer 204. Inferencer 204 may use the encoded input audio data to perform inferencing. The inferencing may include operations to identify words within speech of audio inputs.

The streaming ASR model 210 may be trained using an already trained non-streaming ASR model 220, for example using KD techniques. For example, an encoder 214, including a plurality of non-streaming layers, of the non-streaming ASR model 220 may be used to train the encoder 202. In some examples, the training of the encoder 202 by the encoder 214 may utilize a plurality of auxiliary non-streaming layers 230.

Once the encoder 202 is trained by the encoder 214, the non-streaming ASR model 220 and the auxiliary non-streaming layers 230 may be removed from the system 200 such that when the streaming ASR model 210 receives the input audio data, the streaming ASR model 210 may automatically recognize speech in the input audio data and system 200 may take an action 208 based on the recognized speech. Such automatic speech recognition may be undertaken by streaming ASR model 210 without any additional overhead (e.g., processing power, memory user, latency, etc.) that may be associated with the auxiliary non-streaming layers 230 or the non-streaming ASR model 220. In some examples, the streaming ASR model 210 may perform the automatic speech recognition on-device (e.g., on system 100) and in real-time.

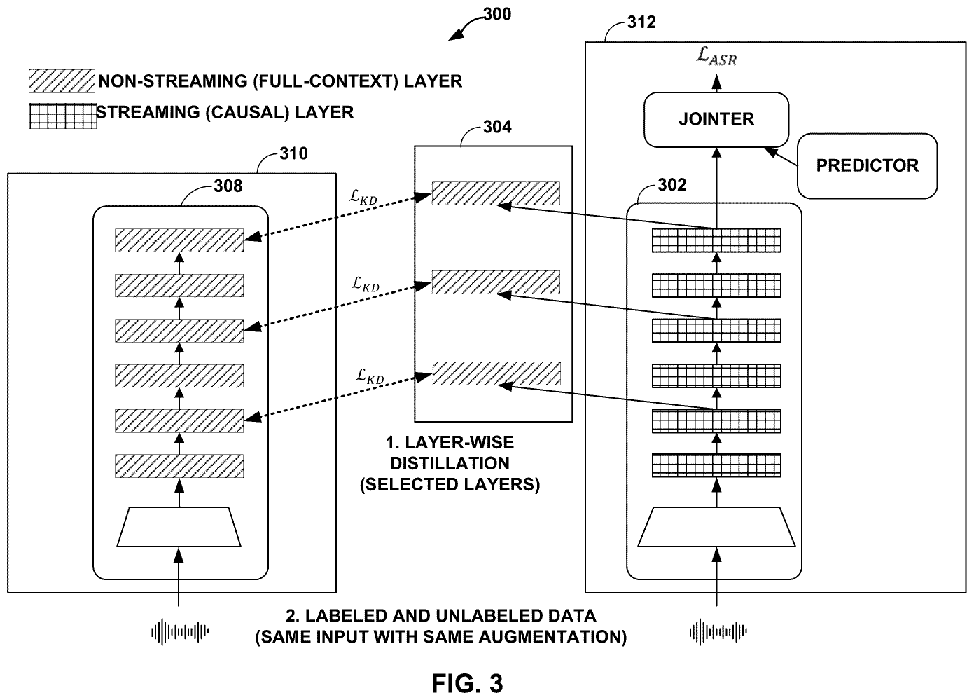

FIG. 3 is a block diagram illustrating example application of KD from a non-streaming ASR model encoder teacher to a streaming ASR model encoder student according to the techniques of this disclosure. System 300 includes a non-streaming ASR model 310, auxiliary non-streaming layers 304, and a streaming ASR model 312. System 300 may represent an example of system 200 during training, with the non-streaming ASR model 310 representing non-streaming ASR model 220, the auxiliary non-streaming layers 304 representing the auxiliary non-streaming layers 230, and the streaming ASR model 212 representing the streaming ASR model 210. The non-streaming ASR model 310 may include an encoder 308, which may represent the encoder 214. The streaming ASR model 312 may include an encoder 302, which may represent the encoder 202.

The encoder 302 may be trained using KD techniques by the encoder 308 via the auxiliary non-streaming layers 304. For example, the encoder 302 may be trained through layer-wise distillation of selected layers (represented by the layers pointed to by the dotted lines). The same input data, which may include labeled data (e.g., a spoken word accompanied by a label identifying the word) and/or unlabeled data (e.g., a spoken word). In some examples, according to the techniques of this disclosure, the KD techniques may be utilized without including any labeled data as input data for training the encoder 302.

During KD training of the encoder 302 by the encoder 308, the auxiliary non-streaming layers 304 may be inserted between the encoder 308 and the encoder 302. In some examples, the auxiliary non-streaming layers 304 may be inserted between the encoder 302 and the encoder 308 on the streaming ASR model 312. In some examples, the auxiliary non-streaming layers 304 may be inserted between the encoder 302 and the encoder 308 on the non-streaming ASR model 310. In some examples, the auxiliary non-streaming layers 304 may be inserted between the encoder 302 and the encoder 308 in a location other than on the non-streaming ASR model 310 and the streaming ASR model 312. Once the encoder 302 is trained, the auxiliary non-streaming layers 304 may be removed so as to not affect the overhead of operating the streaming ASR model 312 when operating to automatically recognize speech (e.g., to make inferences).

When training the encoder 302 using the KD techniques, the trained encoder 308 of the non-streaming ASR model 310, may function as a teacher, while the encoder 302 may function as a student. The layers of the encoder 302 may include only streaming layers, as shown.

In some examples, during the training of the encoder 302 by the encoder 308, the system 350 may use at least one of two losses: an ASR loss and a KD loss. The ASR loss may be used to train the streaming ASR model 312 to accurately transcribe the speech, and the KD loss be used to influence the encoder 302 (e.g., the student) to better follow the behavior of the encoder 308 (e.g., the teacher).

If the input data is labeled, the system 350 may use both the ASR loss and the KD loss. If the input data is unlabeled, the system 350 may use the KD loss only, rather than both the ASR loss and the KD loss. The KD loss (L_{KD}) may be applied to the selected layers of the encoder 308 involved in the training. This KD loss is shown as being applied between the selected layers of encoder 308 and the auxiliary non-streaming layers 304.

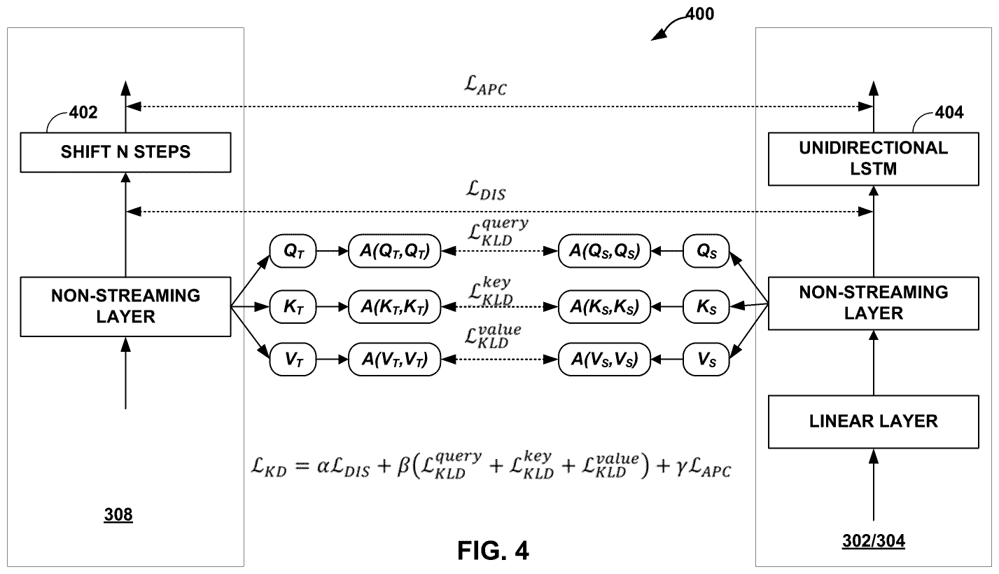

FIG. 4 is a conceptual diagram illustrating an example use of a KD loss function by a system according to the techniques of this disclosure. The system 400 may be an example of the system 300 of FIG. 3. The system 400 may use a specialized KD loss for streaming ASR training. For example, a KD loss function may be determined or computed as a weighted sum of up to three losses. The three losses may include a distance (DIS) loss, a Kullback-Leibler divergence (KLD) loss, and an autoregressive predictive coding (APC) loss.

These three losses may be applied at different points. For example, the KLD loss may be applied between a non-streaming layer of the encoder 308 and an associated non-streaming layer of the auxiliary non-streaming layers 304. The DIS loss may be applied prior to a shift of N steps by the encoder 308 and a unidirectional long-short term memory (LSTM) by the encoder 302. The APC loss may be applied after the shift of N steps 402 by the encoder 308 and the unidirectional LSTM layer 404 by the encoder 302.

The DIS loss may be determined as:

$${L}_{DIS} = {\sum }_{t = 1}^{T} [ \frac{1}{D} ‖ {h}_{t}^{student} - {h}_{t}^{teacher} ‖ - λlogσ ( cos ( {h}_{t}^{student} , {h}_{t}^{teacher} ) ) ]$$

where h is an output feature sequence of teacher/student layer, D is a feature dimension, t is an index of each element in a sequence, and Tis a number of elements in the sequence.

The KLD loss may be determined as:

$${L}_{K L D} = {\sum }_{h = 1}^{H} {\sum }_{t = 1}^{T} K L D ( {a}_{h , t}^{student} , {a}_{h , t}^{teacher} ) , {a}_{h , t} = {Softmax}_{j} ( \frac{{A}_{h , t} {A}_{h , j}^{T}}{\sqrt{{d}_{h}}} )$$

where A is a query/key/value matrix inside a transformer's self-attention layer, h is a self-attention head index, H is a number of heads, and dₕ is a head feature dimension.

The APC loss may be determined as:

$${L}_{A P C} = {Σ}_{t = 1}^{T} [ \frac{1}{D} ‖ {y}_{t}^{student} - {y}_{t + K}^{teacher} ‖ - λlogσ ( cos ( {y}_{t}^{student} , {y}_{t + K}^{teacher} ) ) ]$$

where K is a distance indicating how far a target for prediction is located and y is an output feature sequence of an LSTM layer (e.g., the unidirectional LSTM layer 404).

For example, these three losses may be reinterpreted as performing the following functions: (1) DIS loss: reducing a gap of between the extracted feature of each frame extracted by the encoder 308 and the encoder 302; (2) KLD loss: matching a frame-to-frame relationship between all frames between the encoder 308 and the encoder 302; and (3) APC loss: predicting a future frame by only using the past context. In some examples, the KLD loss may be a combination of three losses: a KLD query loss, a KLD key loss, and a KLD value loss. For example, a KLD query/key/value may correspond to the KLD loss equation above where A is a query/key/value matrix, respectively.

The weighted sum of the three loses may be represented as:

$${L}_{K D} = α {L}_{DIS} + β ( {L}_{K L D}^{query} + {L}_{K L D}^{k e y} + {L}_{K L D}^{v a l u e} ) + γ {L}_{A P C}$$

where L_{KD} is a knowledge distribution loss, L_{DIS} is a distance loss, L_{KLD}^{query} is a KLD query loss, L_{KLD}^{key} is a KLD key loss, L_{KLD}^{value} is a KLD value loss, L_{APC} is an APC loss, and α, β, and γ are weights, as shown in FIG. 4.

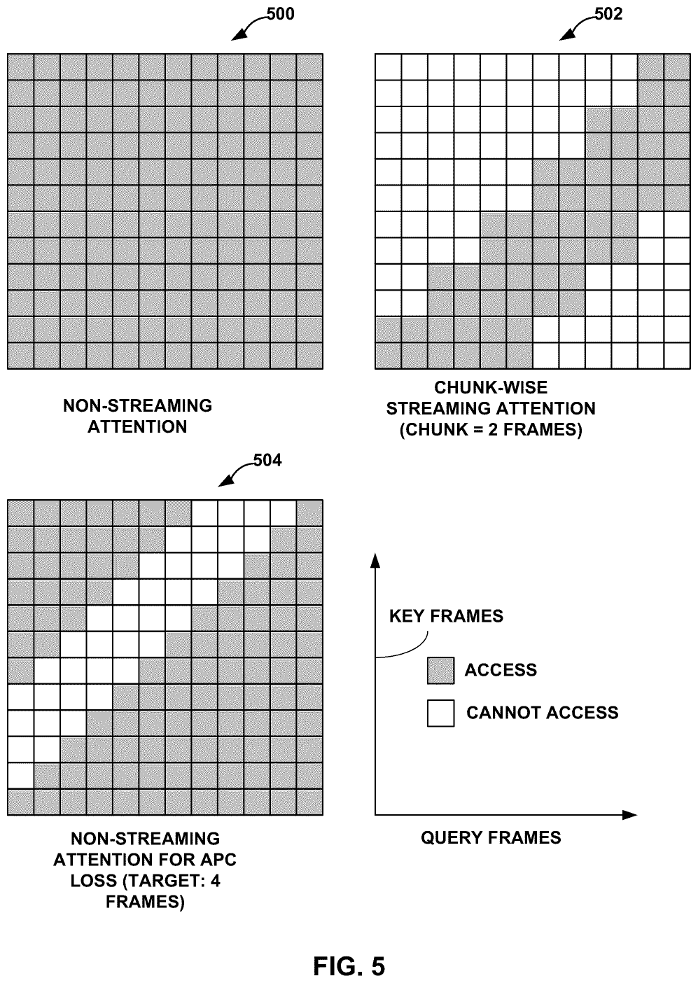

FIG. 5 is a conceptual diagram illustrating example transformer attention masks according to the techniques of this disclosure. Using these three loses discussed with respect to FIG. 4, may be particularly helpful for streaming ASR models, where a model cannot access future information when making an inference.

In non-streaming attention mask 500 of FIG. 5, the X-axis represents a current frame index and the Y-axis represents a target frame. The non-streaming attention mask 500 represents an attention mask of a non-streaming ASR model. Using the non-streaming attention mask 500, during the represented 12 frames, each individual current frame would be able to access all 12 frames, whether the frames were past, present or future frames (relative to the current frame). Using a “chunk-wise” streaming attention mask 502 of FIG. 5, a given current frame is able to access only the frames within the “chunk.” For example, with a 2 frame chunk, the current frame may access the present frame and either the immediate past frame or the immediate future frame, which together with the current frame, make up the 2 frame chunk.

To promote the APC loss of FIG. 4, the system 300 may modify a transformer attention mask. For example, rather than applying the non-streaming attention mask 500 or the chunk-wise streaming attention mask 502, the system 400 may apply the non-streaming attention for APC loss mask 504. In the example applying the non-streaming attention for APC loss mask 504, a current frame may not access the following four frames. This application of a modified transformer attention mask, for example, to the auxiliary non-streaming layers 304 during training, the encoder 302 cannot directly obtain the APC target frame from the self-attention mechanism, thus preventing “cheating” by the encoder 302. For example, the encoder 302 cannot infer the next frame by simply performing a “cut and paste” operation.

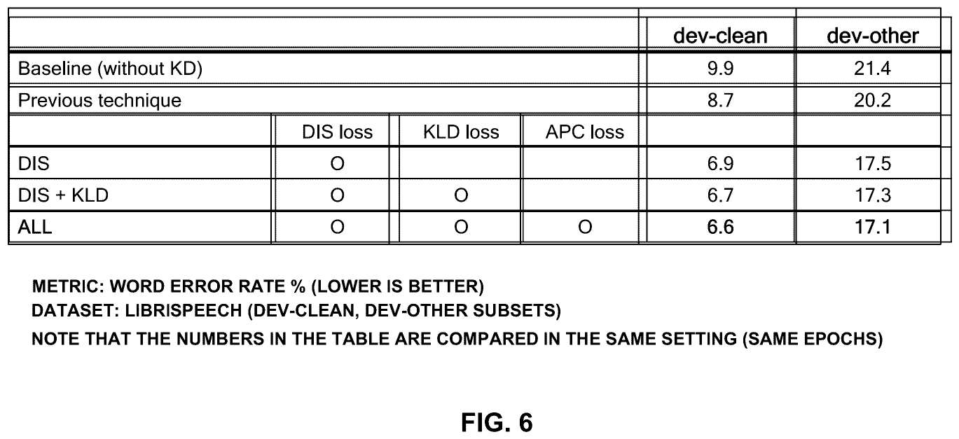

FIG. 6 is a chart illustrating test results of streaming ASR model encoders. A streaming ASR model 312 having an encoder, e.g., the encoder 302, trained according to the techniques of this disclosure, may exhibit improved ASR performance when compared to otherwise trained streaming ASR models. Streaming ASR models were trained using different techniques. A baseline model was tested without using KD. Another model was tested after being trained using previous techniques having KD performed on output token probabilities. A third model was tested after the encoder being trained using a DIS loss as a KD loss. A fourth model was tested after the encoder being trained using DIS and KLD loss to determine the KD loss. A fifth model was tested after the encoder being trained using the DIS, KLD, and APC loss to determine the KD loss.

The displayed metric in FIG. 6 is word error rate (WER) which is presented as a percentage, where a lower percentage WER is better than a higher percentage WER. The dataset used for the testing was LibriSpeech (dev-clean, dev-other subsets). The numbers set forth in FIG. 6 are numbers compared using the same setting (e.g., same epochs). As can be seen from FIG. 6, the techniques of this disclosure resulted in a better WER for a streaming ASR model than previous techniques.

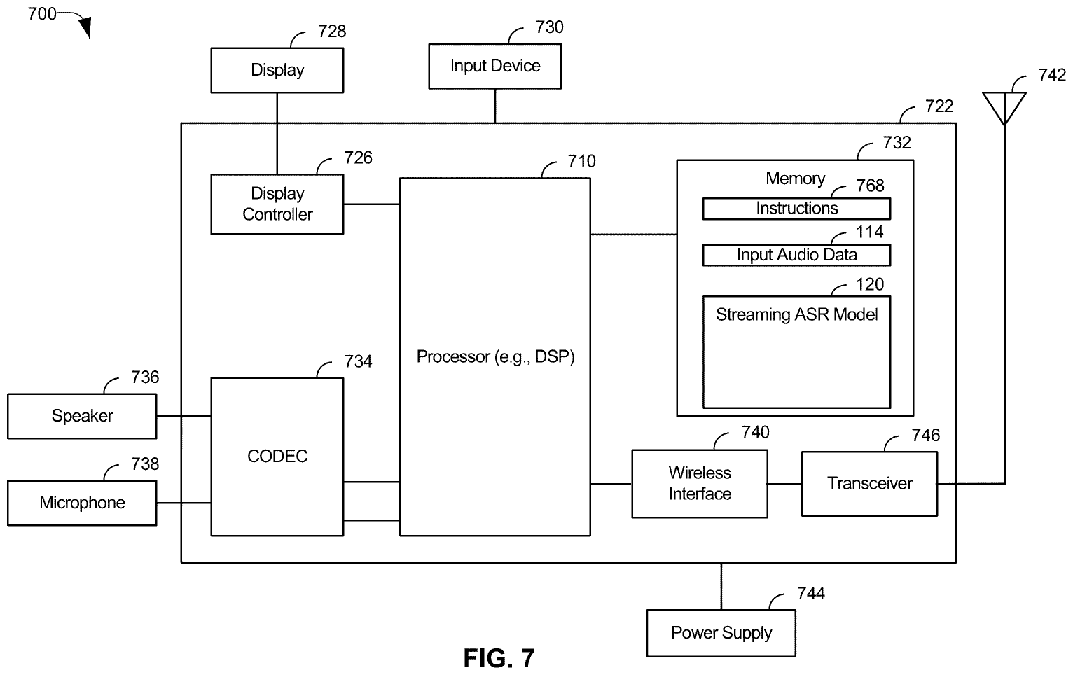

FIG. 7 is a block diagram illustrating an example of a device according to the techniques of this disclosure. In some examples, the device 700 may be a wireless communication device, such as a smartphone. In some examples, the device 700 may have more or fewer components than illustrated in FIG. 7. In an illustrative aspect, the device 700 may perform one or more operations described with reference to the techniques discussed with respect to FIGS. 1-6.

In a particular implementation, the device 700 includes a processor 710, such as a central processing unit (CPU) or a digital signal processor (DSP), coupled to memory 732. The memory 732 includes instructions 768 (e.g., executable instructions) such as computer-readable instructions or processor-readable instructions. The instructions 768 may include one or more instructions that are executable by a computer, such as the processor 710. The memory 732 also includes the streaming ASR model 120 as described with reference to FIG. 1.

The device 700 may include a display controller 726 that is coupled to the processor 710 and to a display 728. A coder/decoder (CODEC) 734 may also be coupled to the processor 710. A speaker 736 and a microphone 738 may be coupled to the CODEC 734.

FIG. 7 also illustrates that a wireless interface 740, such as a wireless controller, and a transceiver 746 may be coupled to the processor 710 and to an antenna 742, such that wireless data received via the antenna 742, the transceiver 746, and the wireless interface 740 may be provided to the processor 710. In some examples, the processor 710, the display controller 726, the memory 732, the CODEC 734, the wireless interface 740, and the transceiver 746 are included in a system-in-package or system-on-chip device 722. In some examples, an input device 730 and a power supply 744 are coupled to the system-on-chip device 722. Moreover, in a particular example, as illustrated in FIG. 7, the display 728, the input device 730, the speaker 736, the microphone 738, the antenna 742, and the power supply 744 are external to the system-on-chip device 722. In a particular implementation, each of the display 728, the input device 730, the speaker 736, the microphone 738, the antenna 742, and the power supply 744 may be coupled to a component of the system-on-chip device 722, such as an interface or a controller.

In some examples, the memory 732 includes or stores the instructions 768 (e.g., executable instructions), such as computer-readable instructions or processor-readable instructions. For example, the memory 732 may include or correspond to a non-transitory, computer readable medium storing the instructions 768. The instructions 768 may include one or more instructions that are executable by a computer, such as the processor 710.

In some examples, the device 700 includes a non-transitory, computer readable medium (e.g., the memory 732) storing instructions (e.g., the instructions 768) that, when executed by one more processors (e.g., the processor 710), may cause the one or more processors to perform operations including determining one or more words in a speech signal (e.g., input audio data 114) based on one or more transfers of learned knowledge from a non-streaming model (e.g., non-streaming ASR model 220) to a streaming model (e.g., streaming ASR model 210), the streaming model including an on-device, real-time streaming model (e.g., streaming ASR model 120). The instructions may also cause the one or more processors to take an action (e.g., action 208) based on the determined one or more words.

The device 700 may include a wireless telephone, a mobile communication device, a mobile device, a mobile phone, a smartphone, a cellular phone, a laptop computer, a desktop computer, a computer, a tablet computer, a set top box, a personal digital assistant (PDA), a display device, a television, a gaming console, an augmented reality (AR) device, a virtual reality (VR) device, a music player, a radio, a video player, an entertainment unit, a communication device, a fixed location data unit, a personal media player, a digital video player, a digital video disc (DVD) player, a tuner, a camera, a navigation device, a decoder system, an encoder system, a vehicle, a component of a vehicle, or any combination thereof.

This disclosure may state that one or more words in a speech signal may be determined based on one or more transfers of learned knowledge from a non-streaming model to a streaming model and that the streaming model is an on-device, real-time streaming model. Such language is intended to include the following examples. Example 1: the transfer of learned knowledge may occur while the streaming model is located on the device (e.g., device 700), for example, while the streaming model is resident in memory 732. Example 2: the transfer of learned knowledge may occur prior to the streaming model being installed on a device, where the streaming model is intended to perform on-device, real-time processing, such as ASR. In other words, streaming ASR model 120 may be trained (e.g., the transfer of learned knowledge from non-streaming ASR model 220 to streaming ASR model 210) while being located on a different device (e.g., in a laboratory, in a cloud computing environment, on a server, etc.) than device 700 before being loaded onto device 700. Example 3: the transfer of learned knowledge may partially occur prior to the streaming model being located on the device and partially occur while the streaming model is located on the device. As such, the transfer of learned knowledge may occur in one or more transfers (e.g., in a single transfer or a plurality of transfers). While located on device 700, streaming ASR model 120 may be said to be an on-device, real-time streaming model.

It should be noted that various functions performed by the one or more components of the systems described with reference the FIGS., and the device 700 are described as being performed by certain components or circuitry. This division of components and circuitry is for illustration only. In an alternate aspect, a function performed by a particular component may be divided amongst multiple components. Moreover, in an alternate aspect, two or more components described with reference to FIGS. 1-7 may be integrated into a single component. Each component described with reference to FIGS. 1-7 may be implemented using hardware (e.g., a field-programmable gate array (FPGA) device, an application-specific integrated circuit (ASIC), a DSP, a controller, etc.), software (e.g., instructions executable by a processor), or any combination thereof.

In conjunction with the described aspects, an apparatus or device may include means for storing one or more category labels associated with one or more categories of a natural language processing library. The means for storing may include or correspond to the memory 104 of FIG. 1, the memory 732 of FIG. 7, one or more other structures or circuits configured to store one or more category labels associated with one or more categories of a natural language processing library, or any combination thereof.

The apparatus or device may further include means for processing. The means for processing may include means for determining one or more words in a speech signal (e.g., input audio data 114) based on one or more transfers of learned knowledge from a non-streaming model (e.g., non-streaming ASR model 220) to a streaming model (e.g., streaming ASR model 210), the streaming model including an on-device, real-time streaming model (e.g., streaming ASR model 120). The means for processing may also include means for taking an action (e.g., action 208) based on the determined one or more words.

One or more of the disclosed aspects may be implemented in a system or an apparatus, such as the device 700, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 700 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, a component integrated within a vehicle, any other device that includes a processor or that stores or retrieves data or computer instructions, or a combination thereof. As another illustrative, non-limiting example, the device 700 may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

While FIG. 7 illustrates a wireless communication device including a processor configured to perform automatic speech recognition, a processor configured to perform automatic speech recognition may be included in various other electronic devices. For example, a processor configured to perform automatic speech recognition as described with references to FIGS. 1-7, may be included in one or more components of a base station.

A base station may be part of a wireless communication system. The wireless communication system may include multiple base stations and multiple wireless devices. The wireless communication system may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA.

Various functions may be performed by one or more components of the base station, such as sending and receiving messages and data (e.g., audio data). The one or more components of the base station may include a processor (e.g., a CPU), a transcoder, a memory, a network connection, a media gateway, a demodulator, a transmission data processor, a receiver data processor, a transmission multiple input-multiple output (MIMO) processor, transmitters and receivers (e.g., transceivers), an array of antennas, or a combination thereof. The base station, or one or more of the components of the base station, may include a processor configured to perform adaptive audio analytics, as described above with reference to FIGS. 1-7.

During operation of a base station, one or more antennas of the base station may receive a data stream from a wireless device. A transceiver may receive the data stream from the one or more antennas and may provide the data stream to the demodulator. The demodulator may demodulate modulated signals of the data stream and provide demodulated data to the receiver data processor. The receiver data processor may extract audio data from the demodulated data and provide the extracted audio data to the processor.

The processor may provide the audio data to the transcoder for transcoding. The decoder of the transcoder may decode the audio data from a first format into decoded audio data and the encoder may encode the decoded audio data into a second format. In some implementations, the encoder may encode the audio data using a higher data rate (e.g., upconvert) or a lower data rate (e.g., downconvert) than received from the wireless device. In other implementations the audio data may not be transcoded. Transcoding operations (e.g., decoding and encoding) may be performed by multiple components of the base station. For example, decoding may be performed by the receiver data processor and encoding may be performed by the transmission data processor. In other implementations, the processor may provide the audio data to the media gateway for conversion to another transmission protocol, coding scheme, or both. The media gateway may provide the converted data to another base station or core network via the network connection.

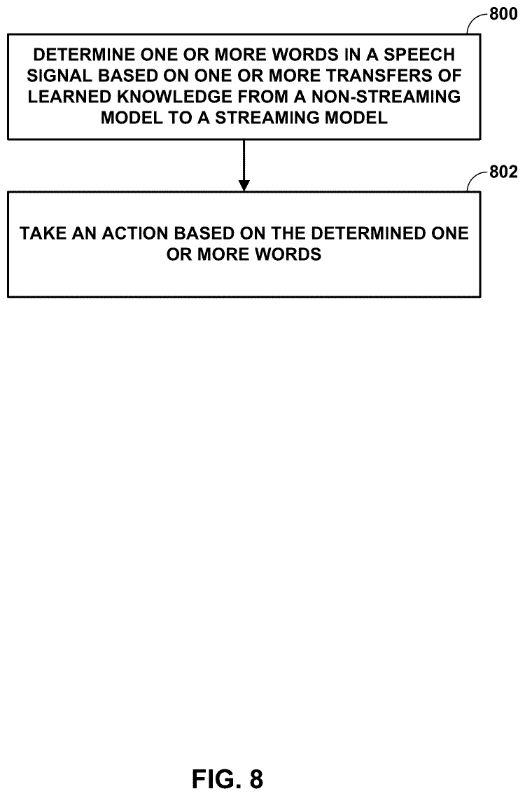

FIG. 8 is a flow diagram illustrating example techniques for KD from a non-streaming to a streaming encoder according to one or more aspects of this disclosure. Processor 102 may determine one or more words in the speech signal based on one or more transfers of learned knowledge from a non-streaming model to a streaming model (800). For example, audio input 112 may include speech. Microphone 110 may capture the speech in audio input 112 and convert the audio input 112 into a signal, such as input audio data 114. Input audio data 114 may include a speech signal.

Processor 102 may execute streaming ASR model 120. Streaming ASR model 120 may be an example of streaming ASR model 210 and/or streaming ASR model 312. Streaming ASR model 210 may be trained by one or more transfers of learned knowledge from non-streaming ASR model 220. Streaming ASR model 312 may be trained by one or more transfers of learned knowledge from non-streaming ASR model 310. Such training may be utilized by processor 102 executing streaming ASR model 120 to determine the one or more words in the speech signal. Streaming ASR model 120 may be an on-device, real-time streaming model. In some examples, streaming ASR model 120 may be trained while resident in memory 104. In some examples, streaming ASR model 120 may be trained prior to streaming ASR model 120 becoming resident in memory 104. For example, streaming ASR model 120 may be trained while streaming ASR model 120 is resident on a different device (e.g., trained prior to being stored in memory 104).

Processor 102 may take an action based on the determined one or more words (802). For example, processor 102 may process the one or more words into text, respond to commands within the one or more words (e.g., turn on the kitchen light in response to determining the one or more words correspond to “turn on the kitchen light”), respond to queries (e.g., retrieve and audibly present a weather report from the Internet in response to determining the one or more words correspond to “what is the current weather”), or the like.

In some examples, the non-streaming model includes a trained non-streaming model and the one or more transfers of learned knowledge from the non-streaming model to the streaming model includes training the streaming model using the non-streaming model. In some examples, wherein the one or more transfers of learned knowledge are based on an encoder (e.g., encoder 121, encoder 202, encoder 214, encoder 302, and/or encoder 308) configured to encode the speech. In some examples, the encoder includes multiple layers. In some examples, the encoder transfers knowledge at selected layers of the multiple layers.

In some examples, the one or more transfers of learned knowledge are from an encoder of the non-streaming model (e.g., encoder 214 and/or encoder 308) to an encoder of the streaming model (e.g., encoder 202 and/or encoder 302). In some examples, the streaming model includes a streaming ASR model (e.g., streaming ASR model 120, streaming ASR model 210, and/or streaming ASR model 312) and the non-streaming model includes a non-streaming ASR model (e.g., non-streaming ASR model 220 and/or non-streaming ASR model 310. In some examples, the one or more transfers of learned knowledge are based on a plurality of auxiliary non-streaming layers (e.g., auxiliary non-streaming layers 230 and/or auxiliary non-streaming layers 304) between the streaming model and the non-streaming model. In some examples, the one or more transfers of learned knowledge are based on a modified attention mask (e.g., of FIG. 5C) associated with the plurality of auxiliary non-streaming layers.

In some examples, the one or more transfers of learned knowledge are based on KD. In some examples, the one or more transfers of learned knowledge are based on a KD loss function. In some examples, the KD loss function includes at least one of a distance loss, a KLD loss, or an autoregressive predictive coding loss. In some examples, the KD loss function includes at least two of a distance loss, a Kullback-Leibler divergence loss, or an autoregressive predictive coding loss. In some examples, the KD loss function includes a weighted sum of the distance loss, the Kullback-Leibler divergence loss, and the autoregressive predictive coding loss. In some examples, the KD loss function includes:

$${L}_{K D} = α {L}_{DIS} + β ( {L}_{K L D}^{query} + {L}_{K L D}^{k e y} + {L}_{K L D}^{v a l u e} ) + γ {L}_{A P C}$$

where L_{KD} is a knowledge distribution loss, L_{DIS} is a distance loss, L_{KLD}^{query} is a KLD query loss, L_{KLD}^{key} is a KLD key loss, L_{KLD}^{value} is a KLD value loss, L_{APC} is an APC loss, and α, β, and γ are weights.

In some examples, the speech includes an utterance. In some examples, the utterance includes the one or more words.

In some examples, at least one of the one or more transfers of learned knowledge occurs prior to the streaming model being located on the device. For example, a transfer of learned knowledge may occur when streaming ASR model 120 is located on a server. In some examples, at least one of the one or more transfers of learned knowledge occurs after the streaming model is located on the device. For example, a transfer of learned knowledge may occur when streaming ASR model 120 is located on device 700. In some examples, the one or more transfers of learned knowledge may partially occur prior to the streaming model being located on the device and partially occur after the streaming model is located on the device.

Although one or more of FIGS. 1-8 may illustrate systems, apparatuses, and/or methods according to the teachings of the disclosure, the disclosure is not limited to these illustrated systems, apparatuses, and/or methods. One or more functions or components of any of FIGS. 1-8 as illustrated or described herein may be combined with one or more other portions of another of FIGS. 1-8. Accordingly, no single implementation described herein should be construed as limiting and implementations of the disclosure may be suitably combined without departing form the teachings of the disclosure. As an example, one or more operations described with reference to FIGS. 1-7 may be optional, may be performed at least partially concurrently, and/or may be performed in a different order than shown or described.

This disclosure include the following non-limiting clauses.
Clause 1A. A device configured to automatically recognize speech, the device comprising: memory configured to store the speech signal representative of speech and an on-device, real-time streaming model; one or more processors implemented in circuitry coupled to the memory, the one or more processors being configured to: determine one or more words in the speech signal based on transfer of learned knowledge from a non-streaming model to the streaming model; and take an action based on the determined one or more words.
Clause 2A. The device of clause 1A, wherein the transfer of learned knowledge is based on an encoder configured to encode the speech.
Clause 3A. The device of clause 2A, wherein the encoder comprises multiple layers.
Clause 4A. The device of clause 3A, wherein the encoder transfers knowledge at selected layers of the multiple layers.
Clause 5A. The device of any of clauses 2A-4A, wherein the transfer of learned knowledge is from an encoder of the non-streaming model to an encoder of the streaming model.
Clause 6A. The device of any of clauses 1A-5A, wherein the streaming model comprises a streaming automatic speech recognition (ASR) model and the non-streaming model comprises a non-streaming ASR model.
Clause 7A. The device of any of clauses 1A-6A, wherein the transfer of learned knowledge is based on a plurality of auxiliary non-streaming layers between the streaming model and the non-streaming model.
Clause 8A. The device of clause 7A, wherein the transfer of learned knowledge is based on a modified attention mask associated with the plurality of auxiliary non-streaming layers.
Clause 9A. The device of any of clauses 1A-8A, wherein the transfer of learned knowledge is based on knowledge distribution (KD).
Clause 10A. The device of clause 9A, wherein the transfer of learned knowledge is based on a KD loss function.
Clause 11A. The device of clause 10A, wherein the KD loss function comprises at least one of a distance loss, a Kullback-Leibler divergence loss, or an autoregressive predictive coding loss.
Clause 12A. The device of clause 11A, wherein the KD loss function comprises at least two of a distance loss, a Kullback-Leibler divergence loss, or an autoregressive predictive coding loss.
Clause 13A. The device of clause 12A, wherein the KD loss function comprises a weighted sum of the distance loss, the Kullback-Leibler divergence loss, and the autoregressive predictive coding loss.
Clause 14A. The device of clause 13A, wherein the KD loss function comprises:

$${L}_{K D} = α {L}_{DIS} + β ( {L}_{K L D}^{query} + {L}_{K L D}^{k e y} + {L}_{K L D}^{v a l u e} ) + γ {L}_{A P C}$$

where L_{KD} is a knowledge distribution loss, L_{DIS} is a distance loss, L_{KLD}^{query} is a KLD key loss, L_{KLD}^{key} is a KLD key loss, L_{KLD}^{value} is a KLD value loss, L_{APC} is an APC loss, and α, β, and γ are weights.
Clause 15A. The device of any of clauses 1A-14A, wherein the speech comprises an utterance.
Clause 16A. The device of clause 15A, wherein the utterance comprises the one or more words.
Clause 17A. The device of any of clauses 1A-16A, further comprising one or more microphones configured to capture the speech signal.
Clause 18A. The device of any of clauses 1A-17A, wherein the transfer of learned knowledge occurs prior to the streaming model being located on the device.
Clause 19A. The device of any of clauses 1A-17A, wherein the transfer of learned knowledge occurs after the streaming model is located on the device.
Clause 20A. The device of any of clauses 1A-19A, wherein the action comprises processing speech into text, responding to a command, or responding to a query.
Clause 21A. A method comprising: determining one or more words in a speech signal based on transfer of learned knowledge from a non-streaming model to a streaming model, the streaming model being an on-device, real-time streaming model; and take an action based on the determined one or more words.
Clause 22A. The method of clause 21A, wherein the transfer of learned knowledge is based on an encoder configured to encode the speech.
Clause 23A. The method of clause 22A, wherein the encoder comprises multiple layers.
Clause 24A. The method of clause 23A, wherein the encoder transfers knowledge at selected layers of the multiple layers.
Clause 25A. The method of any of clauses 21A-24A, wherein the transfer of learned knowledge is from an encoder of the non-streaming model to an encoder of the streaming model.
Clause 26A. The method of any of clauses 21A-25A, wherein the streaming model comprises a streaming automatic speech recognition (ASR) model and the non-streaming model comprises a non-streaming ASR model.
Clause 27A. The method of any of clauses 21A-26A, wherein the transfer of learned knowledge is based on a plurality of auxiliary non-streaming layers between the streaming model and the non-streaming model.
Clause 28A. The method of clause 27A, wherein the transfer of learned knowledge is based on a modified attention mask associated with the plurality of auxiliary non-streaming layers.
Clause 29A. The method of any of clauses 21A-28A, wherein the transfer of learned knowledge is based on knowledge distribution (KD).
Clause 30A. The method of clause 29A, wherein the transfer of learned knowledge is based on a KD loss function.
Clause 31A. The method of clause 30A, wherein the KD loss function comprises at least one of a distance loss, a Kullback-Leibler divergence loss, or an autoregressive predictive coding loss.
Clause 32A. The method of clause 31A, wherein the KD loss function comprises at least two of a distance loss, a Kullback-Leibler divergence loss, or an autoregressive predictive coding loss.
Clause 33A. The method of clause 32A, wherein the KD loss function comprises a weighted sum of the distance loss, the Kullback-Leibler divergence loss, and the autoregressive predictive coding loss.
Clause 34A. The method of clause 33A, wherein the KD loss function comprises:

$${L}_{K D} = α {L}_{DIS} + β ( {L}_{K L D}^{query} + {L}_{K L D}^{k e y} + {L}_{K L D}^{v a l u e} ) + γ {L}_{A P C}$$

where L_{KD} is a knowledge distribution loss, L_{DIS} is a distance loss, L_{KLD}^{query} loss, L_{KLD}^{key} is a KLD key loss, L_{KLD}^{value} is a KLD value loss, L_{APC} is an APC loss, and α, β, and γ are weights.
Clause 35A. The method of any of clauses 21A-34A, wherein the speech comprises an utterance.
Clause 36A. The method of clause 35A, wherein the utterance comprises the one or more words.
Clause 37A. A method of training a streaming model comprising: transferring learned knowledge from a non-streaming model to an on-device, real-time streaming model.
Clause 38A. A non-transitory computer-readable storage medium having stored thereon instructions that, when executed, cause one or more processors to: determine one or more words in the speech signal based on transfer of learned knowledge from a non-streaming model to a streaming model, the streaming model comprising an on-device, real-time streaming model; and take an action based on the determined one or more words.
Clause 39A. A device comprising: means for determining one or more words in the speech signal based on transfer of learned knowledge from a non-streaming model to the streaming model. the streaming model comprising an on-device, real-time streaming model; and means for take an action based on the determined one or more words.
Clause 1B. A device configured to automatically recognize speech, the device comprising: memory configured to store a speech signal representative of speech and a streaming model, the streaming model comprising an on-device, real-time streaming model; one or more processors implemented in circuitry coupled to the memory, the one or more processors being configured to: determine one or more words in the speech signal based on one or more transfers of learned knowledge from a non-streaming model to the streaming model; and take an action based on the determined one or more words.
Clause 2B. The device of clause 1B, wherein the non-streaming model comprises a trained non-streaming model and wherein the one or more transfers of learned knowledge from the non-streaming model to the streaming model comprise training the streaming model using the non-streaming model.
Clause 3B. The device of clause 1B or clause 2B, wherein the one or more transfers of learned knowledge are based on an encoder configured to encode the speech.
Clause 4B. The device of clause 3B, wherein the encoder comprises multiple layers.
Clause 5B. The device of clause 4B, wherein the encoder transfers knowledge at selected layers of the multiple layers.
Clause 6B. The device of any of clauses 3B-5B, wherein the one or more transfers of learned knowledge are from an encoder of the non-streaming model to an encoder of the streaming model.
Clause 7B. The device of any of clauses 1B-6B, wherein the streaming model comprises a streaming automatic speech recognition (ASR) model and the non-streaming model comprises a non-streaming ASR model.
Clause 8B. The device of any of clauses 1B-7B, wherein the one or more transfers of learned knowledge are based on a plurality of auxiliary non-streaming layers between the streaming model and the non-streaming model.
Clause 9B. The device of clause 8B, wherein the one or more transfers of learned knowledge are based on a modified attention mask associated with the plurality of auxiliary non-streaming layers.
Clause 10B. The device of any of clauses 1B-9B, wherein the one or more transfers of learned knowledge are based on a KD loss function.
Clause 11B. The device of clause 10B, wherein the KD loss function comprises at least one of a distance loss, a Kullback-Leibler divergence loss, or an autoregressive predictive coding loss.
Clause 12B. The device of clause 11B, wherein the KD loss function comprises at least two of a distance loss, a Kullback-Leibler divergence loss, or an autoregressive predictive coding loss.
Clause 13B. The device of clause 12B, wherein the KD loss function comprises a weighted sum of the distance loss, the Kullback-Leibler divergence loss, and the autoregressive predictive coding loss.
Clause 14B. The device of clause 13B, wherein the KD loss function comprises:

$${L}_{K D} = α {L}_{DIS} + β ( {L}_{K L D}^{query} + {L}_{K L D}^{k e y} + {L}_{K L D}^{v a l u e} ) + γ {L}_{A P C}$$

where L_{KD} is a knowledge distribution loss, L_{DIS} is a distance loss, L_{KLD}^{query} is a Kullback-Leibler divergence (KLD) query loss, L_{KLD}^{key} is a KLD key loss, L_{KLD}^{value} is a KLD value loss, L_{APC} is an autoregressive predictive coding (APC) loss, and α, β, and γ are weights.
Clause 15B. The device of any of clauses 1B-14B, wherein the speech comprises an utterance comprising the one or more words.
Clause 16B. The device of any of clauses 1B-15B, further comprising one or more microphones configured to capture the speech signal.
Clause 17B. The device of any of clauses 1B-16B, wherein at least one of the one or more transfers of learned knowledge occurs prior to the streaming model being located on the device.
Clause 18B. The device of any of clauses 1B-16B, wherein at least one of the one or more transfers of learned knowledge occurs after the streaming model is located on the device.
Clause 19B. The device of any of clauses 1B-18B, wherein the action comprises at least one of processing speech into text, responding to a command, or responding to a query.
Clause 20B. A method comprising: determining one or more words in a speech signal based on one or more transfers of learned knowledge from a non-streaming model to a streaming model, the streaming model comprising an on-device, real-time streaming model; and taking an action based on the determined one or more words.
Clause 21B. The method of clause 20B, wherein the non-streaming model comprises a trained non-streaming model and wherein the one or more transfers of learned knowledge from the non-streaming model to the streaming model comprise training the streaming model using the non-streaming model.
Clause 22B. The method of clause 20B or clause 21B, wherein the one or more transfers of learned knowledge are based on an encoder configured to encode the speech.
Clause 23B. The method of clause 22B, wherein the encoder comprises multiple layers.
Clause 24B. The method of clause 23B, wherein the encoder transfers knowledge at selected layers of the multiple layers.
Clause 25B. The method of any of clauses 22B-24B, wherein the one or more transfers of learned knowledge are from an encoder of the non-streaming model to an encoder of the streaming model.
Clause 26B. The method of any of clauses 20B-25B, wherein the streaming model comprises a streaming automatic speech recognition (ASR) model and the non-streaming model comprises a non-streaming ASR model.
Clause 27B. The method of any of clauses 20B-26B, wherein the one or more transfers of learned knowledge are based on a plurality of auxiliary non-streaming layers between the streaming model and the non-streaming model.
Clause 28B. The method of any of clauses 20B-27B, wherein the action comprises at least one of processing speech into text, responding to a command, or responding to a query.
Clause 29B. A non-transitory computer-readable storage medium having stored thereon instructions that, when executed, cause one or more processors to: determine one or more words in a speech signal based on one or more transfers of learned knowledge from a non-streaming model to a streaming model, the streaming model comprising an on-device, real-time streaming model; and take an action based on the determined one or more words.
Clause 30B. A device comprising: means for determining one or more words in a speech signal based on one or more transfers of learned knowledge from a non-streaming model to a streaming model; the streaming model comprising an on-device, real-time streaming model; and means for taking an action based on the determined one or more words.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device configured to automatically recognize speech, the device comprising:
memory configured to store a speech signal representative of speech and a streaming model, the streaming model comprising an on-device, real-time streaming model;
one or more processors implemented in circuitry coupled to the memory, the one or more processors being configured to:
determine one or more words in the speech signal based on one or more transfers of learned knowledge from a non-streaming model to the streaming model; and
take an action based on the determined one or more words.

2. The device of claim 1, wherein the non-streaming model comprises a trained non-streaming model and wherein the one or more transfers of learned knowledge from the non-streaming model to the streaming model comprise training the streaming model using the non-streaming model.

3. The device of claim 1, wherein the one or more transfers of learned knowledge are based on an encoder configured to encode the speech.

4. The device of claim 3, wherein the encoder comprises multiple layers.

5. The device of claim 4, wherein the encoder transfers knowledge at selected layers of the multiple layers.

6. The device of claim 3, wherein the one or more transfers of learned knowledge are from an encoder of the non-streaming model to an encoder of the streaming model.

7. The device of claim 1, wherein the streaming model comprises a streaming automatic speech recognition (ASR) model and the non-streaming model comprises a non-streaming ASR model.

8. The device of claim 1, wherein the one or more transfers of learned knowledge are based on a plurality of auxiliary non-streaming layers between the streaming model and the non-streaming model.

9. The device of claim 8, wherein the one or more transfers of learned knowledge are based on a modified attention mask associated with the plurality of auxiliary non-streaming layers.

10. The device of claim 1, wherein the one or more transfers of learned knowledge are based on a KD loss function.

11. The device of claim 10, wherein the KD loss function comprises at least one of a distance loss, a Kullback-Leibler divergence loss, or an autoregressive predictive coding loss.

12. The device of claim 11, wherein the KD loss function comprises at least two of a distance loss, a Kullback-Leibler divergence loss, or an autoregressive predictive coding loss.

13. The device of claim 12, wherein the KD loss function comprises a weighted sum of the distance loss, the Kullback-Leibler divergence loss, and the autoregressive predictive coding loss.

14. The device of claim 13, wherein the KD loss function comprises:
$${L}_{K D} = α {L}_{DIS} + β ( {L}_{K L D}^{query} + {L}_{K L D}^{k e y} + {L}_{K L D}^{v a l u e} ) + γ {L}_{A P C}$$
where L_{KD} is a knowledge distribution loss, L_{DIS} is a distance loss, L_{KLD}^{query} is a Kullback-Leibler divergence (KLD) query loss, L_{KLD}^{key} is a KLD key loss, L_{KLD}^{value} is a KLD value loss, L_{APC} is an autoregressive predictive coding (APC) loss, and α, β, and γ are weights.

15. The device of claim 1, wherein the speech comprises an utterance comprising the one or more words.

16. The device of claim 1, further comprising one or more microphones configured to capture the speech signal.

17. The device of claim 1, wherein at least one of the one or more transfers of learned knowledge occurs prior to the streaming model being located on the device.

18. The device of claim 1, wherein at least one of the one or more transfers of learned knowledge occurs after the streaming model is located on the device.

19. The device of claim 1, wherein the action comprises at least one of processing speech into text, responding to a command, or responding to a query.

20. A method comprising:
determining one or more words in a speech signal based on one or more transfers of learned knowledge from a non-streaming model to a streaming model, the streaming model comprising an on-device, real-time streaming model; and
taking an action based on the determined one or more words.

21. The method of claim 20, wherein the non-streaming model comprises a trained non-streaming model and wherein the one or more transfers of learned knowledge from the non-streaming model to the streaming model comprise training the streaming model using the non-streaming model.

22. The method of claim 20, wherein the one or more transfers of learned knowledge are based on an encoder configured to encode the speech signal.

23. The method of claim 22, wherein the encoder comprises multiple layers.

24. The method of claim 23, wherein the encoder transfers knowledge at selected layers of the multiple layers.

25. The method of claim 22, wherein the one or more transfers of learned knowledge are from an encoder of the non-streaming model to an encoder of the streaming model.

26. The method of claim 20, wherein the streaming model comprises a streaming automatic speech recognition (ASR) model and the non-streaming model comprises a non-streaming ASR model.

27. The method of claim 20, wherein the one or more transfers of learned knowledge are based on a plurality of auxiliary non-streaming layers between the streaming model and the non-streaming model.

28. The method of claim 20, wherein the action comprises at least one of processing speech into text, responding to a command, or responding to a query.

29. A non-transitory computer-readable storage medium having stored thereon instructions that, when executed, cause one or more processors to:
determine one or more words in a speech signal based on one or more transfers of learned knowledge from a non-streaming model to a streaming model, the streaming model comprising an on-device, real-time streaming model; and
take an action based on the determined one or more words.

30. A device comprising:
means for determining one or more words in a speech signal based on one or more transfers of learned knowledge from a non-streaming model to a streaming model, the streaming model comprising an on-device, real-time streaming model; and
means for taking an action based on the determined one or more words.
